(19) United States
(12) Patent Application Publication
(10) Pub. No.: US 2010/0174719 A1
(43) Pub. Date: Jul. 8, 2010

(54) SYSTEM, METHOD, AND PROGRAM PRODUCT FOR PERSONALIZATION OF AN OPEN NETWORK SEARCH ENGINE

(76) Inventor: Jorge Alegre Vilches, Madrid (ES)

Correspondence Address: BAY AREA INTELLECTUAL PROPERTY GROUP, LLC, PO BOX 210459, SAN FRANCISCO, CA, 94121-0459, US

(21) Appl. No.: 12/349,088

(22) Filed: Jan. 6, 2009

(51) Int. Cl. G06F 17/30

(52) U.S. Cl. 707/741; 707/E17.017

(57) ABSTRACT

A system for personalization of a search engine for a network includes a least one search account. A first data structure stores index data for words each having a number of resources less than a first number. A second data structure stores index data for words each having a number of resources greater than the first number and less than a second number. The second data structure can be personalized for the search account. A third data structure stores index data for words each having a number of resources greater than the second number. The third data structure can be personalized for search account. At least one index includes the first data structure, the second data structure and the third data structure where when the search engine responds to a query from a user of a search account, the search engine uses an index corresponding to the search account.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to computerized information retrieval, and more particularly to personalization of an open network search engine that generates personalized search accounts that share a common part of the search system and have a highly customized private physical index design.

### BACKGROUND OF THE INVENTION

Currently known information retrieval systems gather information from a network and maintain a single index structure. Users then search (i.e., query) the system to receive documents (i.e., resources) with a uniform resource locator (URL). Using this method, the query generally consists of a list of words and additional filters, as well as other operators such as, but not limited to, “+”, “−”, “and”, “or”, etc. These traditional search engines have a single index for queries, and, since there is only a single version of the search system, the results for the same word queries are always the same

Relevance is understood to those skilled in the art as the importance of an Internet resource. Relevance is typically measured in scores, with values from 0 to 100. Scores may be altered by weights, also typically from 0 to 100, defined by search designers.

Currently known information retrieval systems also define methods of providing a customized service. This approach takes into account the technical difficulties for having multiple indexes for a large amount of content, resulting in a data structure that is too large to benefit any provider. This approach has been taken by leading Internet search engines such as Google (www.google.com), Rollyo (www.rollyo.com) and others. For example without limitation, one solution allows alternate versions of objects from a cache; however, this solution does not offer a multiple index structure. The main disadvantage is that it becomes too expensive for search designers to build a search account of service using this system since the amount of data is very high. In another solution a system offers a service to search in N number of sites, N being 20. In yet another known solution, users may define a set of web pages and sites, and search queries are placed only on this set of pages and sites. These search solutions provide services where users can search in a list of sites defined by user. However, the search is processed into one index structure due to the technical difficulty and expense of duplicating a costly information infrastructure, and personalization options are low.

Another approach for providing a personalized search service is to reference (i.e., include in data tables) the user id with the index archives. This approach has a single index structure, and queries searches only for content defined by users. Other approaches attempt to personalize in a client-side methodology the index data found in information retrieval systems. However, these approaches personalize a very small set of index data.

There is a need for personalizing the indexes in the market since network users want the ability to personalize search results from search engines. Other known approaches tend to use personal information to provide the user with personalized search results. However, this solution is very unpopular among users since the users are required to disclose personal information.

In view of the foregoing, there is a need for improved techniques for providing methods and systems for the personalization of an open network search engine that uses multiple data indexes and does not require users to disclose personal information.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flow diagram illustrating interaction of exemplary common data structures within a customizable search system, according to an embodiment of the present invention;

FIG. 2 is a block diagram illustrating the exemplary movement of a word passing through an exemplary system of data structures, in accordance with an embodiment of the present invention;

FIG. 3 is a flow diagram illustrating an exemplary index data writer in a customizable search system, in accordance with an embodiment of the present invention;

FIG. 4 is a block diagram illustrating exemplary relevance configuration entities, in accordance with an embodiment of the present invention;

FIG. 5 is a flow diagram illustrating an exemplary link creation process for a customizable search system, in accordance with an embodiment of the present invention;

FIG. 6 is a flow diagram illustrating an exemplary process for calculating an account relevance score in a customizable search system, in accordance with an embodiment of the present invention;

FIGS. 7A and 7B illustrate flow diagrams for exemplary processes for search account index management, in accordance with an embodiment of the present invention. FIG. 7A illustrates an exemplary process for building a search account index, and FIG. 7B illustrates an exemplary process for building an Idx data structure and a Cache data structure for the search account manager;

FIG. 8 is a flow diagram of an exemplary system account builder process, in accordance with an embodiment of the present invention;

FIG. 9 is a flow diagram illustrating an exemplary process for site search indexing, in accordance with an embodiment of the present invention;

FIG. 10 is a flow diagram illustrating an exemplary process for an incremental search account builder, in accordance with an embodiment of the present invention;

FIG. 11 is a block diagram illustrating exemplary query entities and query objects, in accordance with an embodiment of the present invention;

FIG. 12 is a flow diagram of an exemplary query process, in accordance with an embodiment of the present invention;

FIG. 13 is a flow diagram illustrating an exemplary process for building a targeted sample of resources, in accordance with an embodiment of the present invention;

FIG. 14 is a flow diagram of an exemplary process for index creation when a list of queries or words is provided by designers, in accordance with an embodiment of the present invention; and;

FIG. 15 is a block diagram of exemplary interaction among search accounts, in accordance with an embodiment of the present invention; and

FIG. 16 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, a system, method, and program product for personalization of an open network search engine is presented.

In one embodiment a system for personalization of a search engine for a network is presented. The system includes a least one search account. A first data structure at least stores index data for words each having a number of matching resources less than a first number. The first data structure is common for all search accounts. A second data structure at least stores index data for words each having a number of matching resources greater than or equal to the first number and less than a second number, wherein the second data structure can be personalized for the at least one search account to create a private second data structure for the at least one search account. A third data structure at least stores index data for words each having a number of matching resources greater than or equal to the second number, wherein the third data structure can be personalized for the at least one search account to create a private third data structure for the at least one search account. At least one index includes the first data structure, the private second data structure and the private third data structure where when the search engine responds to a query from a user of a search account, the search engine uses an index corresponding to the search account. Another embodiment further includes a plurality of search accounts, a plurality of private second data structures, a plurality of private third data structures and a plurality of indexes. In another embodiment each of the plurality of search accounts further includes a configuration for personalizing data structures. In another embodiment a weight of word location in a resource, a weight of resource properties and weights for linked content based on the configuration. In yet another embodiment the configuration can define relevance of properties of websites. In a further embodiment at least part of the configuration can be replaced by a website configuration contained in a website to be searched. In still another embodiment at least index data for a word can be moved between the first, second and third data structures when the number of matching resources increases. In another embodiment index data can be organized in word location preferences, resource preferences and link preferences based on the configuration. In yet another embodiment a group of resources can be categorized based on the configuration. In still another embodiment the indexes contain index data from indexing only a portion of content on the network.

In another embodiment a system for personalization of a search engine for a network is presented. The system includes a least one search account, first means for storing index data for all search accounts, second means for storing index data that can be personalized for the at least one search account, third means for storing index data that can be personalized for the at least one search account and means for creating at least one index corresponding to the at least one search account where when the search engine responds to a query from a user of a search account, the search engine uses an index corresponding to the search account. Another embodiment further includes a plurality of search accounts where the second and third means store index data for each of the plurality of search accounts and the creating means creates a plurality of indexes corresponding to the plurality of search accounts. Another embodiment further includes means for configuring the plurality of search accounts. Yet another embodiment further includes means for moving index data between the first, second and third means. Still another embodiment further includes means for indexing only a portion of content on the network.

In another embodiment a method for personalization of a search engine for a network is presented. The method includes steps of at least storing index data for words in a first data structure where each word has a number of matching resources less than a first number. The first data structure is common for all search accounts. A step at least stores index data for words in a second data structure where each word has a number of matching resources greater than or equal to the first number and less than a second number, wherein the second data structure can be personalized for at least one search account to create a private second data structure for the at least one search account. A step at least stores index data for words in a third data structure where each word has a number of matching resources greater than or equal to the second number, wherein the third data structure can be personalized for the at least one search account to create a private third data structure for the at least one search account. A step creates at least one index including the first data structure, the private second data structure and the private third data structure where when the search engine responds to a query from a user of a search account, the search engine uses an index corresponding to the search account. In another embodiment the second data structure can be personalized for a plurality of search accounts to create a plurality of private second data structures, the third data structure can be personalized for a plurality of search accounts to create a plurality of private third data structures and the creating creates a plurality of indexes. A further embodiment further includes a step of receiving configuration information for search accounts for personalization of data structures. Yet another embodiment further includes step of determining a weight of word location in a resource, a weight of resource properties and weights for linked content based on the configuration information. Another embodiment further includes a step of defining relevance of properties of websites based on the configuration information. Still another embodiment further includes a step of replacing at least part of the configuration information with a website configuration when a website to be searched contains the website configuration. Another embodiment further includes a step of moving at least index data for a word between the first, second and third data structures when the number of matching resources increases. Yet another embodiment further includes a step of organizing index data in word location preferences, resource preferences and link preferences based on the configuration information. Another embodiment further includes a step of categorizing a group of resources based on the configuration information. Still another embodiment further includes a step of indexing only a portion of content on the network based on the configuration information.

In another embodiment a method for personalization of a search engine for a network is presented. The method includes steps for at least storing index data for words in a first data structure being common for all search accounts, steps for storing index data for words in a second data structure that can be personalized for at least one search account, steps for storing index data for words in a third data structure that can be personalized for the at least one search account and steps for creating at least one index corresponding to the at least one search account where when the search engine responds to a query from a user of a search account, the search engine uses an index corresponding to the search account. In another embodiment the second data structure can be personalized for a plurality of search accounts to create a plurality of private second data structures, the third data structure can be personalized for a plurality of search accounts to create a plurality of private third data structures and the creating creates a plurality of indexes. Another embodiment further includes steps for receiving configuration information for search accounts for personalization of data structures. Yet another embodiment further includes steps for replacing at least part of the configuration information with a website configuration. Still another embodiment further includes steps for moving index data for a word between the first, second and third data structures.

In another embodiment a computer program product for personalization of a search engine for a network is presented. The computer program product includes computer code for at least storing index data for words in a first data structure where each word has a number of matching resources less than a first number, the first data structure being common for all search accounts. Computer code at least stores index data for words in a second data structure where each word has a number of matching resources greater than or equal to the first number and less than a second number, wherein the second data structure can be personalized for at least one search account to create a private second data structure for the at least one search account. Computer code at least stores index data for words in a third data structure where each word has a number of matching resources greater than or equal to the second number, wherein the third data structure can be personalized for the at least one search account to create a private third data structure for the at least one search account. Computer code creates at least one index including the first data structure, the private second data structure and the private third data structure where when the search engine responds to a query from a user of a search account, the search engine uses an index corresponding to the search account. A computer-readable media stores the computer code. In another embodiment the second data structure can be personalized for a plurality of search accounts to create a plurality of private second data structures, the third data structure can be personalized for a plurality of search accounts to create a plurality of private third data structures and the creating creates a plurality of indexes. Another embodiment further includes computer code for receiving configuration information for search accounts for personalization of data structures. Yet another embodiment further includes computer code for determining a weight of word location in a resource, a weight of resource properties and weights for linked content based on the configuration information. Still another embodiment further includes computer code for defining relevance of properties of websites based on the configuration information. Another embodiment further includes computer code for replacing at least part of the configuration information with a website configuration when a website to be searched contains the website configuration. Still another embodiment further includes computer code for moving at least index data for a word between the first, second and third data structures when the number of matching resources increases. Yet another embodiment further includes computer code for organizing index data in word location preferences, resource preferences and link preferences based on the configuration information. Another embodiment further includes computer code for categorizing a group of resources based on the configuration information. Still another embodiment further includes computer code for indexing only a portion of content on the network based on the configuration information.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Preferred embodiments of the present invention provide customization of index structures for large open networks such as, but not limited to, the Internet. The approach taken by preferred embodiments is different in nature from the approaches described in reference to the prior art. Other solutions allow personalization from a single index structure. Preferred embodiments of the present invention, implement a multiple search account system that enables multiple index data structures to be built, offering a higher personalization service to search engine designers and publishers. The system has a common structure and personalized structures for search accounts of individual users. Each user has a search account that the user can customize, personalize and configure. This search account leads to the creation of an index that is distinct and unique for each search account. Each search account in preferred embodiments comprises a private physical data structure for the account owner to manage. The physical data structure may be able to search the entire network (i.e., horizontal) or may be able to search only certain portions of the network (i.e., vertical). Preferred embodiments are typically implemented on the Internet; however, alternate embodiments may be used in any open network for example, without limitation, mobile networks and broadcast networks. Yet other alternate embodiments may be used in closed networks such as, but not limited to, business intranets and document databases (i.e., university libraries). In preferred embodiments, users can use any channel to access the information obtained from search queries such as, but not limited to, mobile phones, television sets, private networks, etc.

In preferred embodiments, search account designers can define index design and other personalization variables. Furthermore in preferred embodiments, search account designers can share information in a search community and regular users can participate to improve the quality of results from the search accounts. The search system in preferred embodiments is implemented in a net of computer nodes and servers, each hosting a specific service. This cluster of nodes provides a high performance for building indexes and searching these indexes. However, alternate embodiments may be implemented in various alternate types of environments such as, but not limited to, personal computers or portable devices, where the services described in the invention can be used to create and search a small index that corresponds to the files located in the personal computer or mobile device. Another, non-limiting possible environment is computer servers that index a small set of resources found in open networks like Internet or closed networks like Intranets. In these environments, the preferred file structure is packed and optimized in order to be effective for the server, desktop computer or portable device.

In the preferred embodiment, each search account has its own configuration that determines the weight of word location in a web page, weight of resource properties and weights for linked content. The customization in preferred embodiments comprises the following levels of defining relevance for resources in the network, word location, basic resource properties, link properties, and advanced resource properties. The word location level defines relevance inside resources for words depending on their location inside the resources, for example, without limitation, the relevance of words found in the titles of resources. Basic relevance properties define the properties associated with resources such as, but not limited to, if the resource is a home page or not, the language of the resource, etc. Designers can define which of these properties are more relevant and which are less relevant. Designers may also define which links are more relevant by defining the relevance of domains and web pages that link to other resources. Designers may also define advanced properties of the relevance system. The relevance of resources defines which results come first and which results come last when users place search queries.

In preferred embodiments, a site search can have a different and separate configuration for word location relevance, resource relevance and linked relevance maintained by the webmaster of the domain to be searched. The webmasters and owners of sites can define a configuration, which is used when indexing data belonging to their sites. When processing the site search index if no configuration is found for the domain, the default account configuration is used. Webmasters are able to submit different configurations for Internet search and for site search in preferred embodiments.

In preferred embodiments, designers may create horizontal index data structures or vertical index data structures. Vertical data indexes can be for cases such as, but not limited to, a specific site, for a list of sites or for a list of words. The list of sites supports a list of domains and a list of URLs. A method for providing vertical search provides a way to build index archives for the whole network yet only for a set of queries or words provided by users and designers. Designers may also manually insert resources for queries and sort the inserted resources with respect to the automatically sorted resources.

In preferred embodiments search accounts can be shared in a community of designers so that a search community can give valuable information to all participants, have search accounts for groups, enable search accounts to link to other search accounts and META search in a set number of search accounts. A META search is a search in which different search sources are searched and the results are merged into one search result, labeling the search source in each result.

Preferred embodiments of the present invention provide methods for users and web sites to enjoy an affordable customized search solution without the costs of developing a search technology and maintaining its infrastructure. Preferred embodiments may enable freedom of search to any kind of user in the Internet and other networks such as, but not limited to, corporate intranets, mobile networks, document database services and broadcast services. Furthermore, the customization proposed for preferred embodiments personalizes search results without the need to disclose personal information by users.

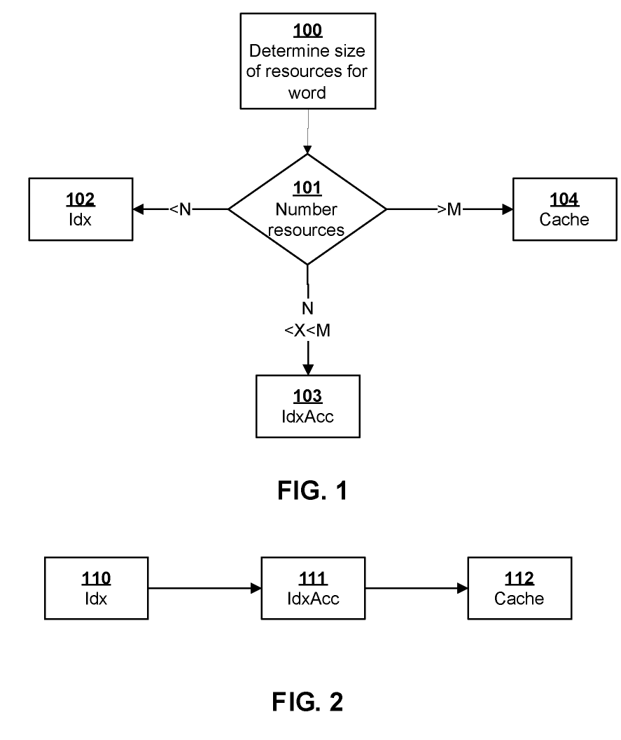

FIG. 1 is a flow diagram illustrating interaction of exemplary common data structures within a customizable search system, according to an embodiment of the present invention. In the present embodiment, three common data structures exist in the system: an Idx data structure, a Cache data structure and an IdxAcc data structure, as shown by way of example in FIG. 2. In step 100 the number of resources matching the word or words of a search is determined. In step 101 the number of resources determined in step 100 is used to determine which data structure is used. These data structures are used so that personalization is optimized and index data sizes are the smallest possible. Only a small percentage of words have to be personalized, saving valuable resources and making the present innovation cost effective. For words that are not very popular the Idx data structure is used. This data structure is not personalized in any means, simply in query time the system gets the data and on real time, relevance is calculated. For more popular words the IdxAcc data structure is used. This data structure is personalized by users and designers and it is optimized for the number of matches that holds for each word. Finally, the Cache data structure holds words that are very popular and therefore have a very big number of matches. The Cache data structure can be partially personalized, to X % of the total number of resources. The value of X depends on the contracted index size by designers. All data structures support writing information and searching. These data structures are places where index data is stored depending on popularity of the indexed words. For words with fewer than N matching resources, the Idx data structure is used in step 102. For words with a number of matching resources N and between N and M the IdxAcc data structure is used in step 103. For words with M or more than M matching resources found, the Cache data structure is used in step 104. In the present embodiment, words can change and pass through data structures depending on the number of matches of each word. The values of N and M can be calibrated as index size increases by system administrators. The data structure topology is important since the index creation is not required to work for all of the words in the system. This decreases the overload of index creation for search accounts.

FIG. 2 is a block diagram illustrating the exemplary movement of a word passing through an exemplary system of data structures, in accordance with an embodiment of the present invention. In the present embodiment, a word can pass from an Idx data structure 110 to an IdxAcc data structure 111 and end at a Cache data structure 112. Word index data must move or be promoted from one data structure to another depending to the overall matches for that word since data structures are optimized for words depending if they are rarely used, popular or very popular.

Idx data structure 110 stores data with duplicate keys, having the word number as a key. Index data is stored following the pattern key−>value. For the Idx data structure the key is duplicate, which means many keys can have the same value but the value is different. The key for Idx data structure corresponds to a system word counter named “Word Number”. Storing data with duplicate keys enables two keys to have the same value (which is not the same as the value of the data associated with the key, like key−>data) and to be sorted following some criteria. In the present embodiment, the key data is not sorted. The words are stored in partitions, each partition having a set number of words. The number of words stored in the partitions can be increased and decreased as index size increases or for performance purposes. Index data related to the words is stored in Idx data structure 110 as well as data related to the resource itself, such as, but not limited to, resource details such as, but not limited to, URL, description, etc. The data in Idx data structure 110 has a data structure that can support advanced queries with detailed index information. Advanced queries are queries that have additional search criteria apart from the words such as, but not limited to word location, resource language, links to other resources, home page operator, date operators, type of content, etc. . . .

In the present embodiment, IdxAcc data structure 111 stores information differently from Idx data structure 110, having an index archive for each word. The word number is the key in these index archives. The key value is the detailed index information, which also supports advanced queries. Cache data structure 112 stores information with one archive for each word. In Cache data structure 112, the word number is the key, and the key value is the index data, which also supports advanced queries.

The key value has a similar design for all data structures. The key value comprises information pertaining to the number of occurrences of words in different locations such as, but not limited to, in the uniform resource locator (URL), the title, the META Description, META keywords, the first lines of text, the document BODY tag, bolded tags (e.g., <b> and <strong>), header tags (e.g., <h1>, <h2> and <h3>), a text link for outside links, a text link for inside links, etc. The key value also comprises information pertaining to the resources itself such as, but not limited to, language, geographic zone, content type, host number, domain number, home flag, number of days from 1 Jan. 1971, etc. Information about resources and word locations are used when searching in advanced mode.

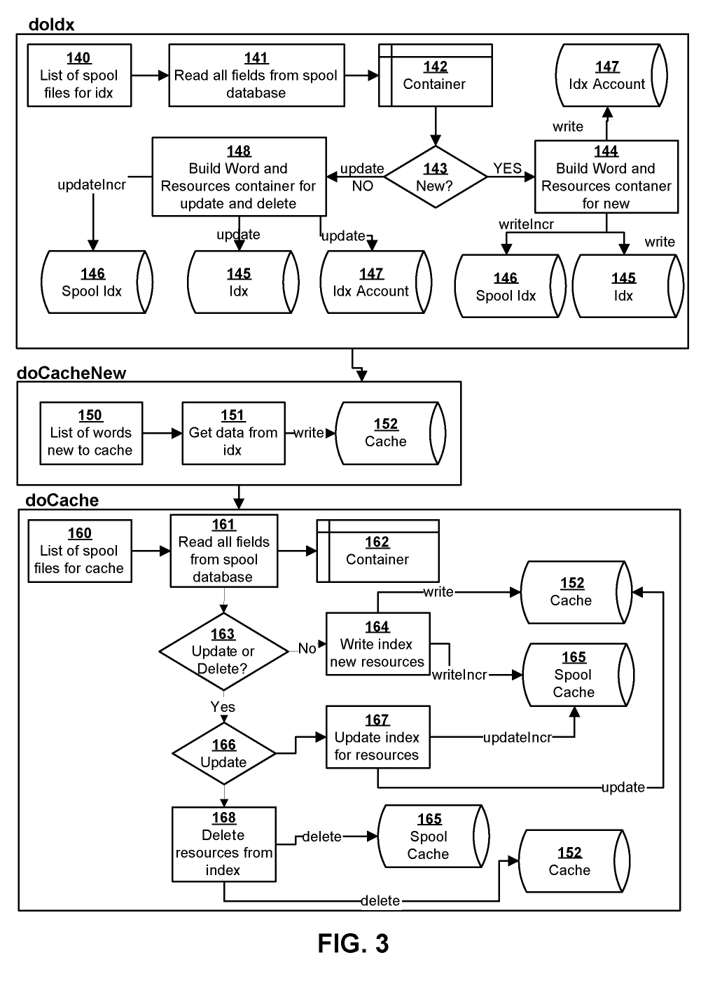

FIG. 3 is a flow diagram illustrating an exemplary index data writer in a customizable search system, in accordance with an embodiment of the present invention. In the present embodiment, a robot can obtain resources from an open network, then process the content of these resources, and write all of the data into a spool. This spool is processed by the index data writer. The process index data writer writes the indexed information from the spool into the index data structures, for example, without limitation, Idx data structure 102, IdxAcc data structure 103 and Cache data structure 104 shown by way of example in FIG. 2. First, the data from the Idx data structure is processed, then the new words are sent to the Cache data structure, and finally the information is sent to the Cache data structure.

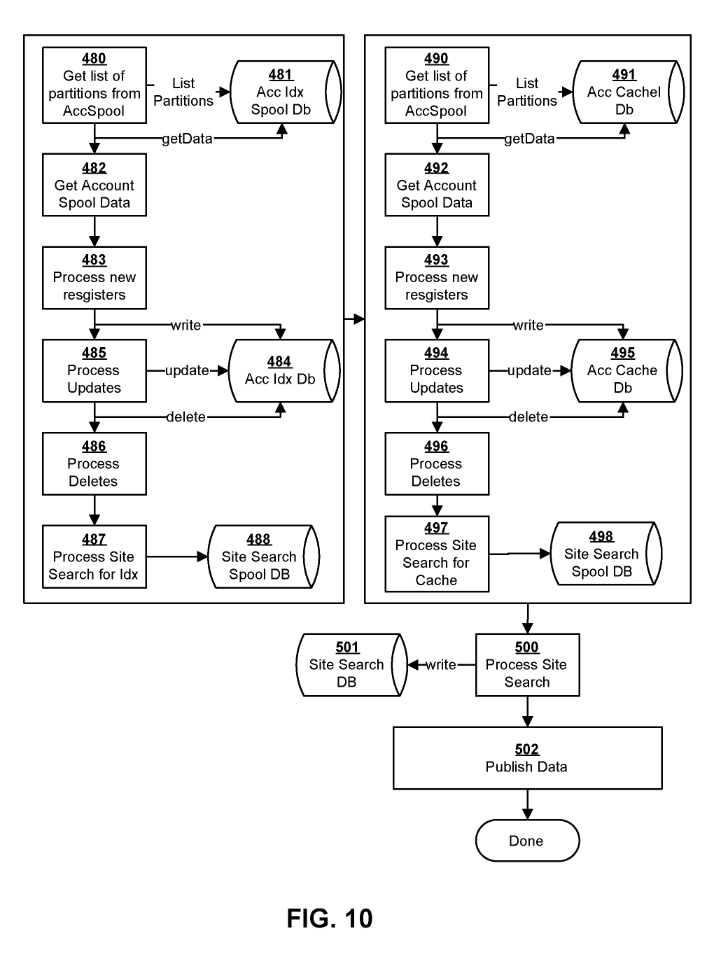

Referring to FIG. 3, the process retrieves the list of spool files for the Idx data structure in step 140. Then all of the fields from the spool table are read in step 141. For the same partition, the spool comprises a set number of fields for the different date periods. Information is saved into a memory container in step 142 for performance implications. In step 143 it is determined if a resource is new. For new resources, the system builds a container for words and resources in step 144. The container writes to the Idx data structure in step 145, to the IdxAcc data structure in step 147 and to the spool index for incremental search accounts where data is processed in time periods in step 146. In the case that the resource is not new and the information for the resource is being updated, a container is built for words and resources for updating and deleting in step 148. This container also writes into the Idx data structure in step 145, the IdxAcc data structure in step 147 and into the spool account search in step 146 for incremental search account building, as describe in the incremental procedure in FIG. 10. The same method is used for both updating and deleting resources since the method uses a cursor to process the table from first row to last row, updating the fields to be updated and deleting the fields to be deleted. The delete arrow in the figure corresponds to the deletion of idx data when word is promoted from idx to idxacc structure as described in some detail below.

After processing the Idx portion of the index data writer, new words eligible for cache are processed. First, the list of words new to cache is compiled in step 150. Then, in step 151, index data from the Idx portion is gathered, and this information is written into the Cache data structure in step 152. Then index data is deleted from the Idx structure 145 since data is already stored in Cache. When promoting words from the Idx data structure to the Cache data structure, the system writes the cache data when a limit has been reached and there are still resources in the Idx data structure. Therefore, this process records data still saved in the Idx data structure to the Cache data structure. The update and delete logic is the same as previously described, since data is gathered from Idx partitions using a cursor from the first register to the last register of the partitions.

Finally, the cache is processed to add new resources, update current resources and delete resources. First, a list of spool files for the cache is gathered in step 160, and all fields from the spool are read in step 161. Data is saved into a memory container in step 162. In step 163 it is determined if a resource is new or if the resource is an existing resource to be updated or deleted. In the case of new resources, the system writes an index of the new resources in step 164. The system writes the new resources into the Cache data structure in step 152 and into an incremental spool search account in step 165. If the resource is an existing resource to be updated or deleted, the system determines if the recourse is to be updated in step 166. In the case of updating, the system updates the index for the resource in step 167 and saves the data into the Cache data structure in step 152 and into the incremental spool search accounts in step 165. In the case of deleting a resource, the system deletes the resource from the index in step 168 and then deletes the resource from the Cache data structure in step 152 and from the incremental spool search account in step 165.

Relevance System

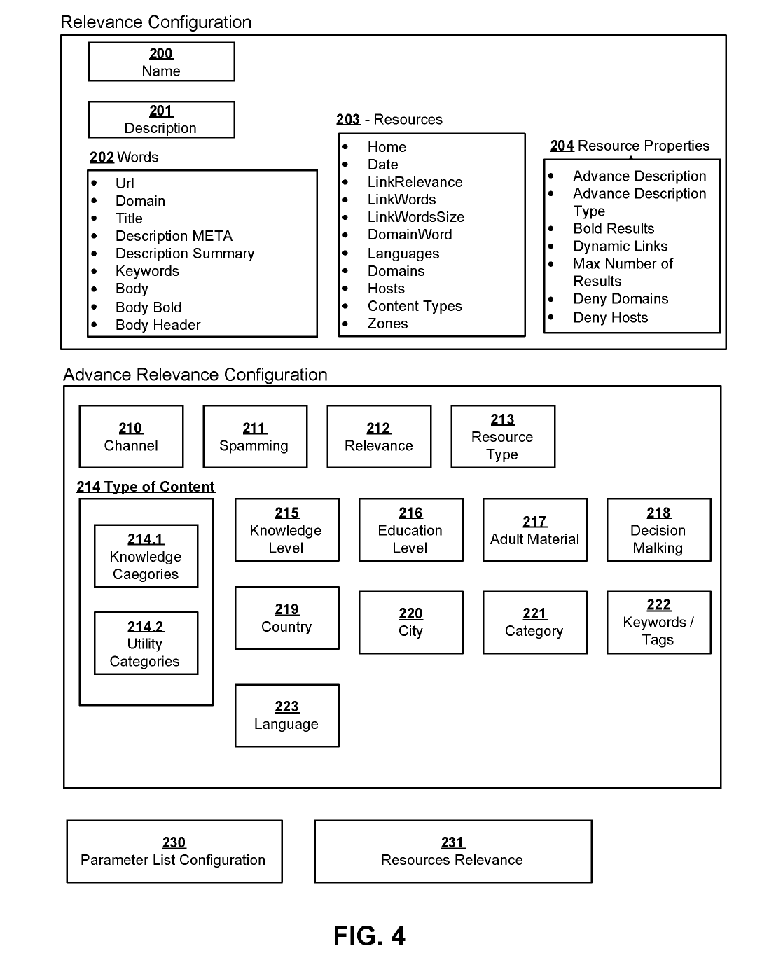

FIG. 4 is a block diagram illustrating exemplary relevance configuration entities, in accordance with an embodiment of the present invention. In the present embodiment, users define a name 200 and a description 201 of their search system (i.e., account), which is shown to other users. Users may also define the relevance of various entities. Relevance is typically defined as weights from 0 to 100. Users may define weights so that some entities are more important than others are. Those skilled in the art, in light of the present teachings, will readily recognize that multiple suitable alternate methods for defining the relevance of resources may be used for example, without limitation a ten star system, where a ten star corresponds to a weight of 100 and no star corresponds to a weight of 0.

Users define relevance of words in a word entity 202 depending on word position on Internet resource. Users may define the relevance of words found in various locations for example, without limitation, in a URL, in a META description tag, in a META keywords tag, in the first ten lines of a document, in BODY tags of HTML documents, etc. In the case that the resource is non HTML media such as, but not limited to, Word documents, users may define the relevance of words found in the text inside a document. In HTML documents users may define relevance in <b> tags and <strong> tags, or in common header tags such as, but not limited to, <h1>, <h2>, <hn>, etc.

Furthermore, users may define the relevance of resources within a resources entity 203. Users may define relevance for resources such as, but not limited to, home pages, other web sites, documents, multimedia content like audio files and video files, podcasts, office resources like spreadsheets, presentations, and any sort of data in XML format. Within resources entity 203 the user may define the date relevance of resources, which is the relevance of the latest documents and documents that correspond to a date rage. In the present embodiment, defining link relevance enables the user to define the relevance of documents found in the relevance system as a factor from 0.0 to 1.0. In alternate embodiments the link relevance may be defined as various alternate factors for example, without limitation, from 1 to 10. When documents in a network link to each other, the system indexes text inside the name of the link and the relevance of the words found in these hypertext links, or LinkWords, may be defined. The user may also define the relevance of the number of entries for LinkWords, which is the number of URLs that are shown indexing only the text inside the links. The relevance of words found in domain names and words found in host names may be defined. The relevance of content types may be defined by the user. These content types define the type of media content, for example, without limitation, HTML page, Word document, spreadsheet, etc. Users may define weights for certain types of document, so these types of documents have more importance than others. Furthermore, weights can be defined for a list of content types. Geographic zones may also be assigned a relevance weight; for example, without limitation, weights may be defined for different languages processed by the search system.

In the present embodiment, users may define the resource properties of a search account 204. For example, without limitation the user may set the size of text fragments for the results, which are the pieces of text shown in the query results for each document. The text fragment is the piece of text more relevant for the search query, for example, without limitation, a search inside a document. The user may also set the type of format for text fragments. For example, without limitation, the format may be set to the best fragment of a group of N lines grouped together that better match the query, or the top N lines that match query found in different regions of documents. The user may set the account to query bolder results. Bolder results are results tagged with a bold font. The maximum number of results returned by the system to the account may also be set by the user. The account may also be programmed to deny domains, meaning that the user can define certain domain names that are not returned in search queries. The documents that belong to these domains are also not shown in the search results. The user may also deny hosts to define host names that are not to be returned in search queries.

In the present embodiment, users may also configure the weights for the relevance system that defines a set of properties (210-223). The present embodiment, comprises a channel property 210, a spamming property 211, a relevance property 212, a resource type property 213, a type of content property 214, a knowledge level property 215, an education level property 216, an adult material property 217, a decision making property 218, a country property 219, a city property 220, a category property 221, a keywords and tags property 222, and a language property 223. Those skilled in the art, in light of the present teachings, will readily recognize that there is a multiplicity of suitable alternate or additional properties that may be included in alternate embodiments. These advanced properties are defined by humans cataloging the way resources link to other resources in the relevance system guided by a computerized method. What this means is that a computer method generates the most probable links to be categorized. Then, a human team categorizes the most relevant content provided by the computer method.

For each resource in the relevance system, all or some of these properties are defined by editors using a manual procedure. The resources are either a domain (i.e., site) or a single web page. The human procedure defines the properties of the linked resources from either a domain or web page. Therefore, these properties do not belong to the resource itself but to the group of linked resources from a web page. All links from the group have same properties. This group can belong to the links from a domain or the links in a page. Search account designers can then weight the properties defined in the relevance system, to personalize their search accounts. In the present embodiment, weights range from 0 to 100; however, weights may vary in alternate embodiments. If the weight is defined as 0, the link resource relevance is inactive.

In the present embodiment, editors define the following properties. A channel property 210 is a type of communication. The following channels are defined in the present embodiment, “Web”, “Mobile Web” and “Offline Activities”. However, various other channels may be defined in alternate embodiments, such as, but not limited to, any offline content media like newspapers, magazines, library documents, any broadcast content from broadcast networks or any content from mobile networks and mobile devices like mobile phones or PDAs, any content from private networks, intranets. Resources are defined with a spamming level in spamming properties 211 that indicate the probability of spamming coming from that resource. Exemplary spamming levels defined within spamming properties 211 may include, without limitation, “Very high probability of spamming”, “High probability, can have spamming”, “Low risk of spamming”, and “Not spamming at all”. Spamming is defined as those web pages that link to other web pages in a compulsive manner or having a commercial activity. Therefore, the value of those links may be lower depending on the spamming level. Exemplary weights on importance of relevance levels defined in relevance properties 212 in the search system for links may include, without limitation, “Very high relevance”, “High relevance”, “Normal”, “Low relevance” and “Not relevant”. In alternate embodiments relevance levels may be defined differently, for example, without limitation, with numerical scores, etc. Resource types properties 213 are defined by the type of net content within the resource. For example, without limitation, resource types may be defined as “News”, “Forums”, “Blogs”, “Web page”, “Commercial web page”, “Shopping site”, and “Non profit and educational web page”. Those skilled in the art, in light of the present teachings, will readily recognize that resource types may be defined differently in alternate embodiments, for example, without limitation, resource types may be more specific as in “Local News”, “International News”, etc. or may be more broad as in “Commercial” and “Non-commercial”.

Designers may define weights for types of content within type of content properties 214. Types of content properties 214 comprise information about the type of information in a particular resource. The list of content types expands as link resources are added to the system, and these content types comprise knowledge related categories 214.1 and utility related categories 214.2. Knowledge categories 214.1 comprise information about the type of knowledge shared by the resource, for example, without limitation, “Basic Information”, “Personal Opinion”, “FAQs”, “How-to Guides”, “News and Information”, “Learning a topic”, “Mastering a topic”, “Company product information”, “Information about Standard”, etc. Utility Categories 214.2 define how the information in the link resources may be used. Exemplary utility categories may include, without limitation, “Apply information on professional work”, “Use information for free time”, “Do it myself”, “Sharing information”, etc.

In the present embodiment, content in the relevance system is cataloged with knowledge levels within knowledge properties 215. These levels may include, without limitation, “Expert”, “Know about it”, “Know some”, “Beginner”, “Don't have a clue”, etc. The education level of the content within a resource is defined in Education Level properties 216. Exemplary education levels may include, without limitation, “School”, “High School”, “University”, “University Post Grade”, etc. Adult Material properties 217 comprise resources that link to adult only sites. Decision Making properties 218 define content that is targeted to people which have a certain decision in buying activities or any commercial decision, as well as those people which influence other people in blogs, etc. . . . although they do not decide on commercial buying activities. Exemplary levels of decision making may include, without limitation, “Have final decision”, “Influence on decisions”, “Have some influence”, “Don't have any influence at all”.

In the present embodiment, the relevance system comprises country information for each resource within country properties 219, which is fed by editors. The relevance system also comprises information about cities related to linked content within city properties 220. The human editors categorize linked resources defining a list of categories based on topics within category properties 221. These categories have a hierarchy of topics. Human editors may define keywords important for resources that link to other resources within keywords and tags properties 222. Therefore, designers may define weights on certain keywords so that link resources have higher relevance with a set of defined keywords. Human editors also define languages for link resources within language properties 223. This language definition is not the same as the actual language of a resource defined by the language identification module, which is a machine decision. Language property 223 defines the language that the human editor feels is more relevant for resources linked in a domain or web page. Language property 223 is selected by editors for web pages or domains with a high-targeted language. Editors may define linked content relative to gender as “Male” or “Female” within gender properties 224.

In the present embodiments, designers may group properties in sets within a parameter list configuration property 230, so that the designers may query for a group of properties. Designers may also offer this property group search to the users of their search account. Designers may also define weights for single resources found in the relevance system. The designers may define weights for URLs, domains and hosts within a resources relevance property 231. This enables the designers to define their personal relevance mapping of all relevant information in the search system, giving the system a high level of personalization and customization.

Those skilled in the art, in light of the present teachings, will readily recognize that a multiplicity of suitable additional and alternate properties of resources that may be used to define the relevance of these resources may be used in alternate embodiments such as, but not limited to, properties relative to way of linking from one resource to another (i.e., linking maps), properties relative to keywords and linking maps, that is, not considering only link relevance but relevance of the link and the keyword together, and properties using any other alternate method for authoritative content (i.e., not only links), like reputation methods, either online and offline.

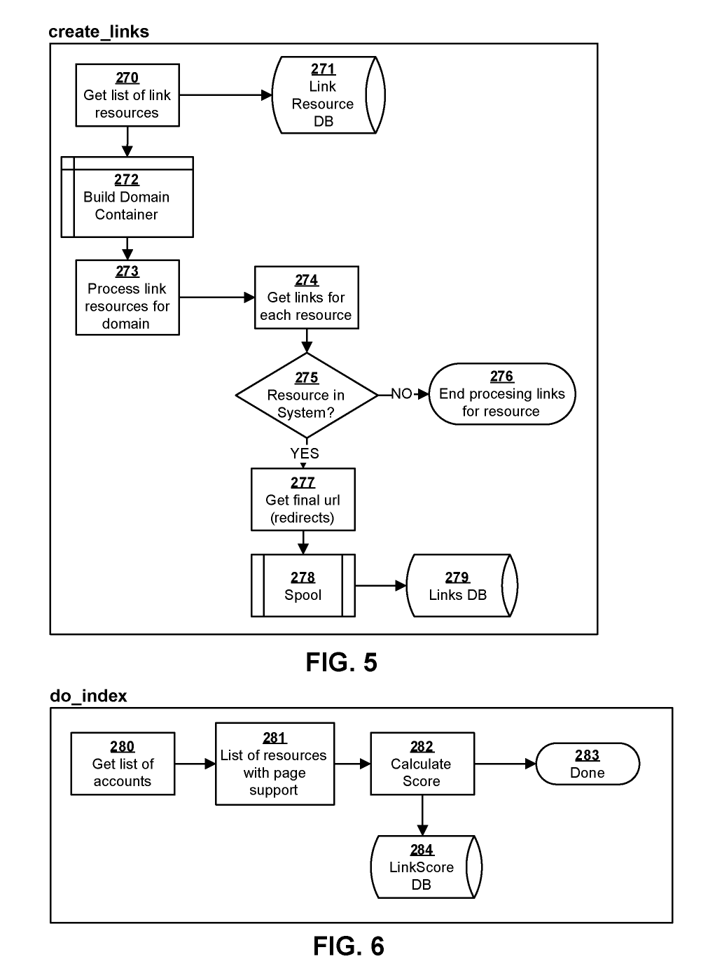

FIG. 5 is a flow diagram illustrating an exemplary link creation process for a customizable search system, in accordance with an embodiment of the present invention. In the present embodiment, the link creation procedure builds links found on link resources recorded by human editors. A LINKS table is created from the information found in a LINK_RESOURCES table, which is fed by editors. Resource links in the LINK_RESOURCES table are already found in the search system. Resource links not found in the search system are recorded in a link resources database for later processing.

The list of link resources is obtained in step 270 from a link resource database 271. As the list is obtained, data is saved in a domain container in memory with a key value as the domain name of the resource in step 272. After this is completed, the link resources are processed for each domain in step 273. For each domain, data is obtained from the domain container for link resources, and the links for each of the resources are obtained in step 274 while processing the tags in the HTML relative to anchors (e.g., <a>*</a>) obtaining the URLs found. The URLs for the resources are searched for in the search system in step 275. If the URL is not found in the search system, the processing ends in step 276. If the resource is found in the search system, all of the possible redirects for the URL are gathered until the final redirect is obtained from a Robi database in step 277. The Robi database contains all resources fetched, with entities relative to the Request and Response to a web page, that is, contains the response code (status), the URL, in general any data relative to the Request and Response header fields. This database has historic information, therefore it is possible to list all requests in time for resource, being very useful for getting information about redirects, not found documents, how many not found documents in time, how many redirects, etc. . . . This data is saved into a memory container spool in step 278. After the spool is filled, the data is recorded to the links database in step 279, resetting the spool and ending the process.

FIG. 6 is a flow diagram illustrating an exemplary process for calculating an account relevance score in a customizable search system, in accordance with an embodiment of the present invention. In the present embodiment, this process determines the score from 0.0 to 1.0 for resources found in the relevance system. In alternate embodiments the range for the score may vary. This score depends on the weights defined by the search account designer. This process enables search account designers to customize the weight for a single link resource or a group of linked resources, as described by way of example in reference to resources relevance property 231 shown b way of example in FIG. 4.

In the present embodiment, this process uses the account names as a parameter. If no account name is defined, the score is calculated for all accounts. First, a list of accounts is obtained in step 280. Then a list of link resources from the relevance system is obtained in step 281. The score for each resource is calculated based on the weights defined in the search account in step 282. Data is then saved into a Link Score database in step 284.

The score saved into the Link Score database refers to the link relevance score. The link score is calculated multiplying the factor saved in the database from 0.0 to 1.0 by 100 and normalizing to a maximum score of Y. The final score is built from this final link score plus word location relevance and resource relevance. Each of these groups of relevance scores has Y maximum points. The three relevance score groups compose a maximum final score of Y*3 points.

Search account designers define the final total score modifying the scores for the three groups. The property link relevance, as illustrated by way of example in FIG. 4 in resource relevance property 231, defines the importance of link relevance. If a designer wishes to define only weights without the link relevance, the link relevance score is set to 0. All of the scores are calculated taking into account the word location and nature of the resources, for example, without limitation, the language, zone, home page, etc. The score for word location is obtained from the weights defined the search account designers. The score for resource relevance is obtained from the weights defined by search account designers. In the present embodiment, only these three groups for relevance are used and have been defined, but other relevance groups can be also defined depending on link properties, authoritative properties, web page entities, any property defined in FIG. 4 as well as changing the way final score is obtained using any other statistical methods.

Search Account Building

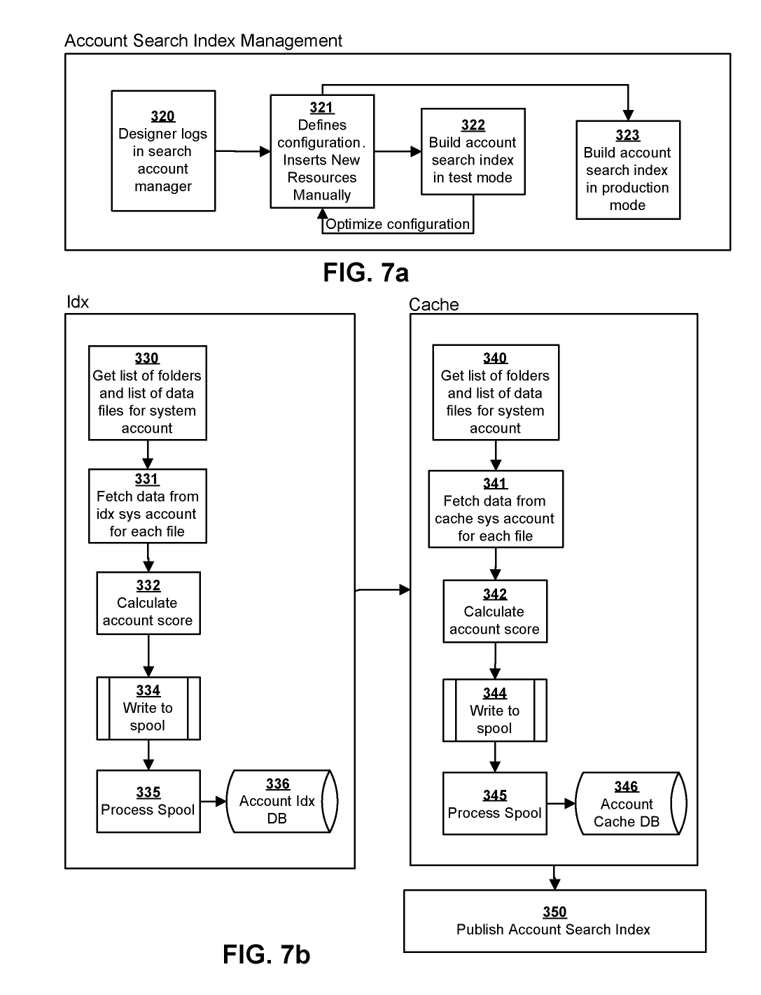

FIGS. 7A and 7B illustrate flow diagrams for exemplary processes for search account index management, in accordance with an embodiment of the present invention. FIG. 7A illustrates an exemplary process for building a search account index, and FIG. 7B illustrates an exemplary process for building an Idx data structure and a Cache data structure for the search account manager. In the present embodiment, these processes are triggered by search account designers from an online procedure. However in alternate embodiments, these procedures may be triggered by a multiplicity of suitable alternate means including, but not limited to, by users in an online procedure, automatically by system depending on programmed rules defined by users or designers, or triggered by email or any other messaging method from the designers or users.

Referring to FIG. 7A, search account designers begin managing accounts by logging into a search account manager with a user Id and password in step 320. The designer defines the search account configuration, defining the weights for the relevance system in step 321. The designer may do this by uploading XML files that define their configuration or by using wizards for this purpose. These wizards have different levels of complexity; for example, without limitation, designers may select beginner wizards, normal wizards or advanced wizards. Search account designers may also insert resources manually for example, without limitation, by clicking on a link in any site in an open network that supports the search system and set the order for certain queries for the manually entered content and the order for the automatic query results from the search system.

Designers then build the search account index in a test mode in step 322. The index building procedure accepts two different environments, a testing environment and a production environment. In the present embodiment, designers may define configuration, build a test index and test search queries. Then repeat this procedure until satisfied with the query results. This activity enables the search designer to optimize the configuration for the search account. When designers decide to go to production with the search configuration, the search account is built in the production environment in step 323.

When the designer decides to build the search account in the production environment, for example, without limitation, by clicking on a “Build Search Account” link or other command link or button, the request is sent to the backend system, triggering the procedure for search account building, defined in the “Idx” and “Cache” portions of the search account manager. Referring to FIG. 7B, the process of defining the search account in the Idx portion of the search account manager begins when a list of folders for the system account is gathered in step 330. Then a list of “Idx” system account database files is gathered from an “Idx” system account in step 331. Data for each file in every folder is processed. The following methods correspond to each database file. After a file has been processed, the next one in the same folder is obtained. After all files in the same folder are obtained, the next folder and its database files are obtained. The score is calculated for each record of the system account in step 332 until a limit is reached. This limit is based on the size of the search account. For example, without limitation, search accounts may have sizes such as, but not limited to, small, medium, big, and huge. The score is obtained from the designer search account. Data is written to a container spool in memory in step 334. After all data from the system account in the database file has been processed, the spool is processed in step 335 and the data is recorded to an Account Idx Database in step 336. This process is repeated for all database files found in the system account for the “Idx” data structure.

After the Idx data structure is built, the Cache data structure is processed. First, a list of folders for system account is gathered in step 340. Then, a list of database files for each folder is fetched from system account database files in step 341. A score is calculated for each record for the system account in step 342 until a limit is reached. This limit is based on the size of the search account, for example, without limitation, small, medium, big, or huge. The score is obtained from the designer search account. Data is written to a container spool in memory in step 344. The spool is processed in step 345, and the data is recorded in an account cache database in step 346. This procedure is repeated for all of the database files found in the system account for the Cache data structure.

After the Idx and Cache data structures have been processed for the designer search account, data is published into the testing environment in step 350. This enables users to place queries and search in testing mode. An alternative embodiment, stores indexes in pairs or triplets of words (instead of storing an index of word=>index data), like wordword=>index data, wordwordword=>index data. Hence, the method for FIGS. 7a and 7b would be the same, except that storing also sets of words in alternate indexes, that is, files for indexes for one word, files for two word and files for three words

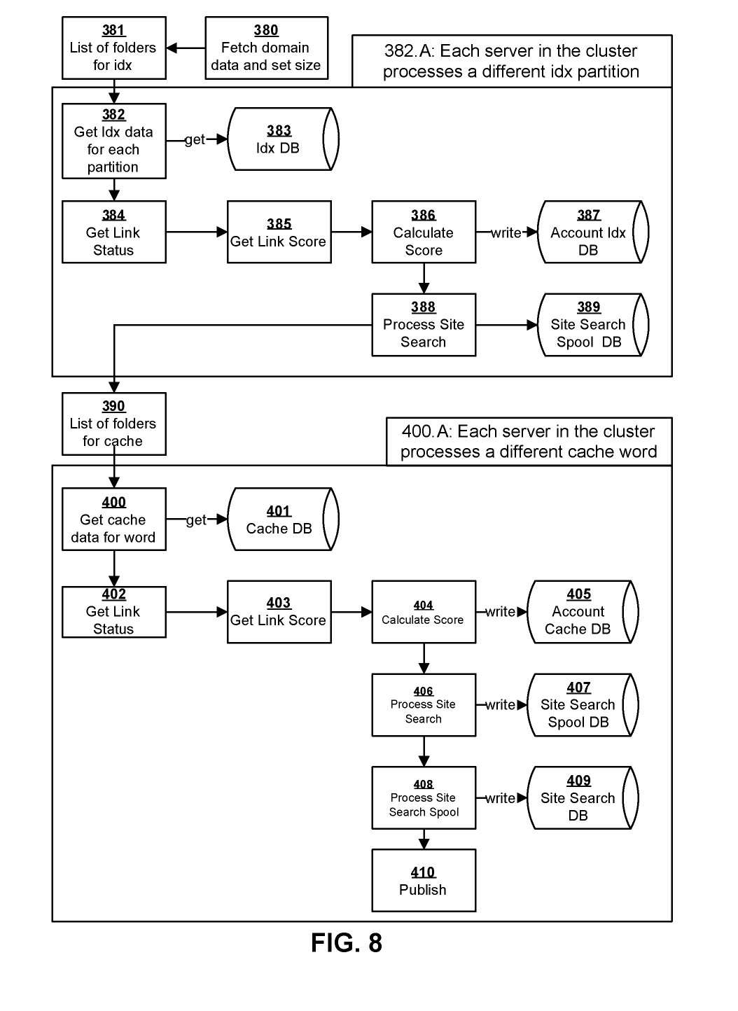

FIG. 8 is a flow diagram of an exemplary system account builder process, in accordance with an embodiment of the present invention. This process builds the system search account from the Idx, IdxAcc and Cache data structures for the system account and large accounts. In the present embodiment, the process is hosted in a cluster environment, where each node of the cluster processes a partition of Idx, IdxAcc and Cache data structures. This allows for parallel processing for building index files for the system account and large accounts.

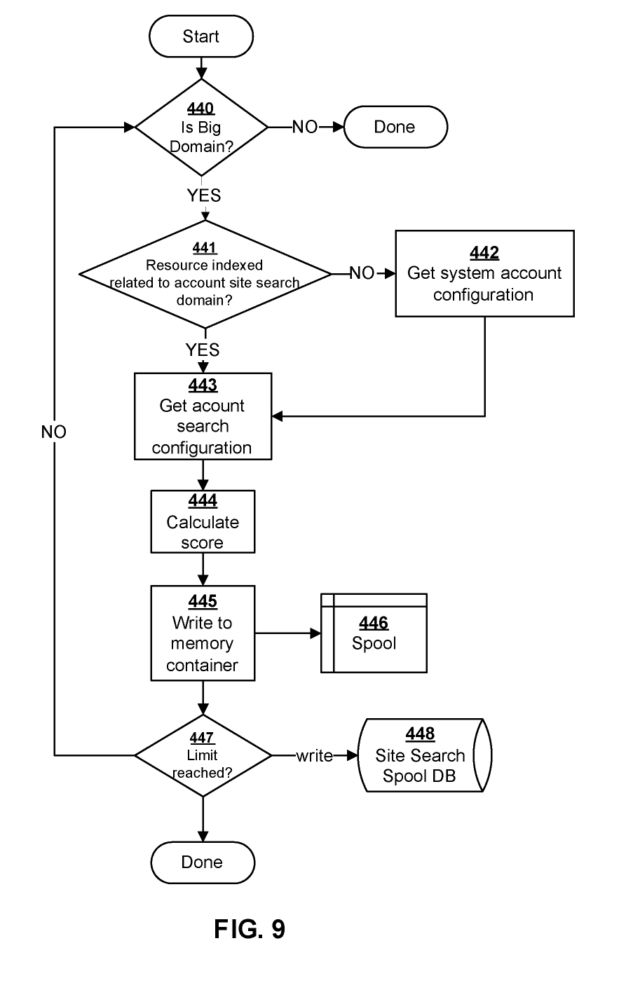

First, domain data is retrieved from a database and the domain size is set in step 380. The logic to search for sites is different in case of a small domain or a big domain as shown by way of example in FIG. 9. If the domain is a big domain, an index is built for the domain, and when users query a search, the search is placed on the vertical index. In the case of a small domain, all resources for the domain are gathered, and then a search is placed within the results.

After the domain size is set, a list of folders for the Idx data structure is obtained in step 381. Then in step 382, a list of Idx partitions for each folder is gathered, and the Idx partition is opened and Idx data is fetched with a cursor from an Idx database 383. In the present embodiment, each server in the cluster processes a different Idx partition. In an alternate embodiment, the index files described for search accounts may be physically placed in a cluster of nodes. In this case, the files are placed in a number of nodes instead of in a single server. In the present embodiment, the Idx partitions have duplicated index values for the same word number that corresponds to the index data for words found in the resources. A list of words is gathered, and then a list of resources is gathered for each word. Link status is obtained in step 384, which is 1 for resources found in the relevance system and 0 otherwise. This information is saved into the index files so the query procedures generally know if a resource belongs to the link relevance system. The link score is obtained in step 385, which is produced in a process for calculating an account relevance score, for example, without limitation, the process shown by way of example in FIG. 6. The final score is calculated in step 386 based on the link score and the relevance for word location and resource properties, for example without limitation, the properties illustrated by way of example in FIG. 4. The configuration is sent within the search account entity, which has all of the information about the account. Data is saved into an account Idx database in step 387. Then, a site search is processed in step 388, and the site search data is written to a site search spool in step 389.

FIG. 9 is a flow diagram illustrating an exemplary process for site search indexing, in accordance with an embodiment of the present invention. First, a flag is obtained to indicate if the domain is big or small in step 440. The domain size is the number of resources indexed for the domain. If it is a small domain, nothing is processed. In the case of big domains, the process continues with obtaining a site search account configuration. Search designers can define a configuration for internet search, with index building, and a configuration for their site search, without index building. In step 441 it is determined if the resource indexed is related to a domain in the account database with site search configuration. If the resource indexed is related to a domain in the account database with site search configuration, the site search configuration is retrieved in step 443 so the account configuration may begin building a score. If the resource is not related to a domain, the system configuration for site search is obtained in step 442. After getting information about the account configuration, the site search score is built in step 444. The data is recorded into a memory spool container in step 445. In step 447 the process determines if a limit on number of resources written to spool has been reached. If the limit has not been reached, the process returns to step 440. Once the limit is reached, the spool is cleaned, and the data is written to a database, “Site Search Spool Database” in step 448.

Referring to FIG. 8, after the site search is processed, the cache data structure is processed. First a list of folders is obtained in step 390. Then a list of words is gathered for each folder in step 400 from a cache database 401. In the present embodiment, each server in the cluster processes a different cache word. Link status is obtained in step 402, which tells if the resource is contained in the link relevance system. This information is recorded into the cache data structure. Then, the link score is obtained in step 403. The final score is calculated in step 404, which comprises the link score, word score and resource score. The data is recorded to an account cache database in step 405. Site search information is processed in step 406 similarly to what is processed for the Idx data structure. This site search data is recorded into a site search spool database in step 407. The site search spool for the Idx and Cache data structures are processed in step 408, and the data is recorded into a site search database in step 409. The Idx and Cache account indexes are published to a testing environment in step 410. After this procedure is completed, the index files in the testing environment can be promoted to a production environment. In doing so, data is distributed to the nodes that build the search accounts.

The foregoing procedure processes the system account index files, processing all of the data from the search system, and building the first X number of resources for each word. This procedure is suited for once-processing. The following procedure describes an exemplary process for the incremental building of a system account index.

FIG. 10 is a flow diagram illustrating an exemplary process for an incremental search account builder, in accordance with an embodiment of the present invention. First a list of partition files is obtained from an account spool in step 480 using account an Idx spool database 481. Account spool data is then obtained from Idx spool database 481 in step 482. New registers are processed in step 483, then updates are processed in step 485, and deletes are processed in step 486. The new register, update and delete data is recorded into an account Idx database 484. The processing procedure takes into account that some words do not exist in account indexes and special logic is followed. If the partition does not exist, logic is followed to create a partition with all of the words. If the partition and word exists, the maximum score is reviewed and compared to the resource score being processed. If the resource score is higher than the maximum score, the data is recorded. Data is fetched with a cursor, fetching from first register to last. For each register, scores for new resources are compared, updated and deleted. In the case of updating in step 485, the register is moved from the old score position to a new score position within account Idx database 484. In the case of deleting in step 486, the index data is deleted from account Idx database 484. In step 487, site search data is processed in a process similar to the process illustrated by way of example in FIG. 9. Site search data is processed for big domains. If the domain is big, it is determined if a site search account exists for the domain, and if so, the data is written to a site search spool database 488.

After processing the account spool for the Idx data structure, the account spool for the Cache data structure is processed. First a list of partitions is gathered from an account cache spool in step 490 using an account cache database 491. Then, a list of cache words and process resources is obtained from account cache database 491 in step 492. New registers are processed in step 493, updates are processed in step 494, and deletes are processed in step 496 comparing the resource score with the highest score, similarly to the procedure for the Idx data. New resources are written, existing resources are updated by moving the ordering of scores, and unwanted registers are deleted in an account cache database 495. The site search for Cache data is processed in step 497, writing the data to a site search spool database 498.

After the Idx and Cache data is recorded, the site search spool data is processed in step 500, writing to a site search database 501. Then, data is published to all testing environments. Designers can promote the data to production use once testing is complete.

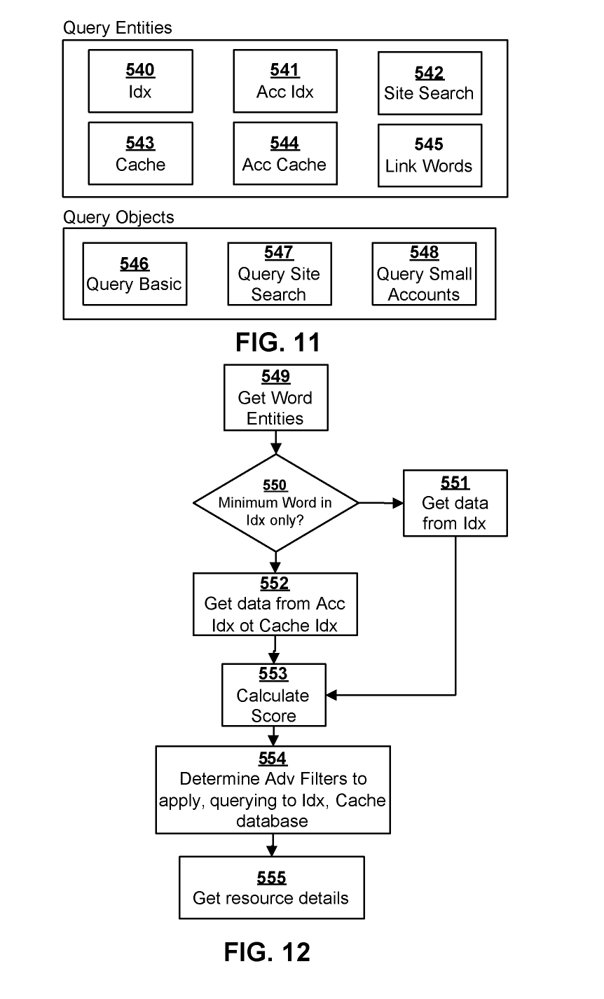

FIG. 11 is a block diagram illustrating exemplary query entities and query objects, in accordance with an embodiment of the present invention. In the present embodiment, the query entities comprise an Idx entity 540, an AccIdx entity 541, a Site Search entity 542, a Cache entity 543, an AccCache entity 544 and a Link Words entity 545.

Idx entity 540 comprises the index data for words with a small number of resources, as shown by way of example in FIG. 1. For words with a higher number of resources, IdxAcc entity 541 is used. For words with more resources Cache entity 543 is used. The number of resources that determines which entity in which the word is placed is set by the system administrators. Site Search entity 542 is used for searching for big domains. Link Words entity 545 is used to search in a links text database. Account entities AccIdx entity 541 and AccCache entity 544 hold the relevance map for each account. Therefore, the index data is sorted by relevance, which is defined by the search account designer.

When users place a search in a search service web site in the present embodiment, a request is sent to the backend system, where query services reside. The following query objects exist: a Query Basic object 546, a Query Site Search object 547 and a Query Small Accounts object 548. Query Basic object 546 is called when the query is placed in the system account and site search is not selected. Site search is understood by defining the parameters needed to search within a site (i.e., a domain or host), indicated for example, without limitation, by a parameter “site” or by any other means in the search service web pages. Query Site Search object 547 is called when users search inside a domain or host. If the domain is big, the search is performed inside the domain index file, returning the resources that belong to the domain or host. In the case of a small domain, all resources for the domain or host are obtained, and then, by a memory process, resources are returned that apply for the search query.

Query Small Account object 548 is called when there is a search in a search account not in the system account. This search mode uses AccIdx entity 541 and AccCache entity 544 for the search account. Query Small Account object 548 can search in a simple mode or an advanced mode. Simple mode refers to searching just for the words. In the present embodiment, the advanced mode uses various parameters in search including, but not limited to, language, geographic zone, title words, keywords words, description words, URL words, body words, bolded words, header words, link words, links, date, etc. This enables search users to filter content based on selection criteria that is based on resources or words. For words, users can place searches depending on word location, for example, without limitation, title, keywords, description, URL, body of document, bolded content, header content, etc. For resources, users can filter by geographic zone, language, resources that link to a URL, and resources that are linked by a URL. Finally, users can filter by resource date, getting the latest content or content between a defined range of dates.

FIG. 12 is a flow diagram of an exemplary query process, in accordance with an embodiment of the present invention. This process is similar for Query Basic object 546 and Query Small Accounts object 548 yet varies for Query Site Search object 547, all shown by way of example in FIG. 11. Query Site Search objects 547 do not support advanced searches and uses the site search database for big domains and for small domains fetches all content and calculates scores. Query Small Accounts objects 548 search the account index database AccIdx, AccCache for the search account. Query Basic objects 546 support advance search and uses the system account data indexes inside AccIdx and AccCache.

In the present embodiment, after a search request is sent to services query-1 and query-n in the backend system, word entities are gathered inside the search query from a database in step 549. Then the process determines what type of word the smallest word is in step 550, which is the word with the minimum number of resources. If this word type is Idx, data is retrieved from the Idx data structure in step 551. If this word type is not Idx, data is retrieved from the AccIdx data structure or the AccCache data structure in step 552. In the case that the word type is Idx, all of the data from the Idx data structure is retrieved and processed in memory due to the small number of resources. In the case that the AccIdx data structure or the AccCache data structure is used, cursors for data files are opened, starting with the first register, then the second register, etc. until the end of the file is reached. All of the account files are opened up front, and then cursors are used to fetch data. For each resource it is determined if the resource number exists in all of the other words. Since the AccIdx data structure has less data than the IdxAcc data structure, the AccIdx data structure is searched first and then the IdxAcc data structure is searched if the query is not found in the AccIdx data structure. The same procedure is done for the Cache data structure, first the AccCache data structure is searched and then the Cache data structure. If the resource number is found in all of the words, the resource number satisfies the search criteria.

Then the query score is calculated in step 553, which depends on the score of each of the words, being a simple mean of all the scores. The data in memory is sorted for the query score, and a final resource list is built. It is determined in step 554 if advanced query parameters are selected. If advanced query parameters are selected, it is verified that the resource number has been found for all of the words in the previous search list. Then it is determined if the resource number satisfies the advanced search criteria in step 554. If the resource number satisfies the advanced search criteria, the resource number is appended to the final search results as a new list. After the final list of resources is obtained, resource details such as, but not limited to, URL, resource fragments, size and other parameters relative to the resource are obtained in step 555.

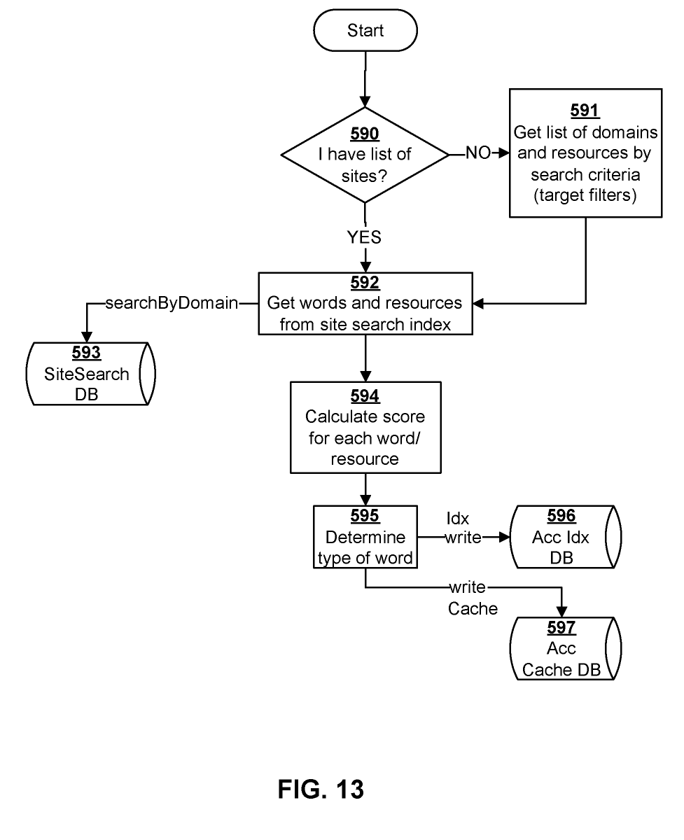

FIG. 13 is a flow diagram illustrating an exemplary process for building a targeted sample of resources, in accordance with an embodiment of the present invention. This process creates an index for a list of sites and an index for a list of sites that satisfies search criteria. This process is used when building a search account with a very small sample of resources compared to the overall number of resources inside the system. For example, without limitation, this process may be used for site search lists. This process may also be used for accounts having search criteria so small that a targeted procedure is needed for performance reasons.

In step 590 it is determined if the user has a list of sites. If so, word data and resources for the list of sites are gathered in step 592. If not, a list of domains and resources is gathered using search criteria and target filters in step 591. These target filters can be any of the advanced search parameters, a combination of advanced search parameters, or any other combination that provides a list of domains or resources. In step 592, after the word data for the list is gathered, the site search database is queried in step 593 searching by domain name. The score for each word is calculated in step 594. Then the type of word is determined in step 595. If the word is of the Idx type, the data is written to an account AccIdx database in step 596. If the word is of the Cache type, the data is written to an account AccCache database in step 597. This process is repeated for all resources and domains affected. The size of the index is smaller than general search accounts, and speed is increased substantially.

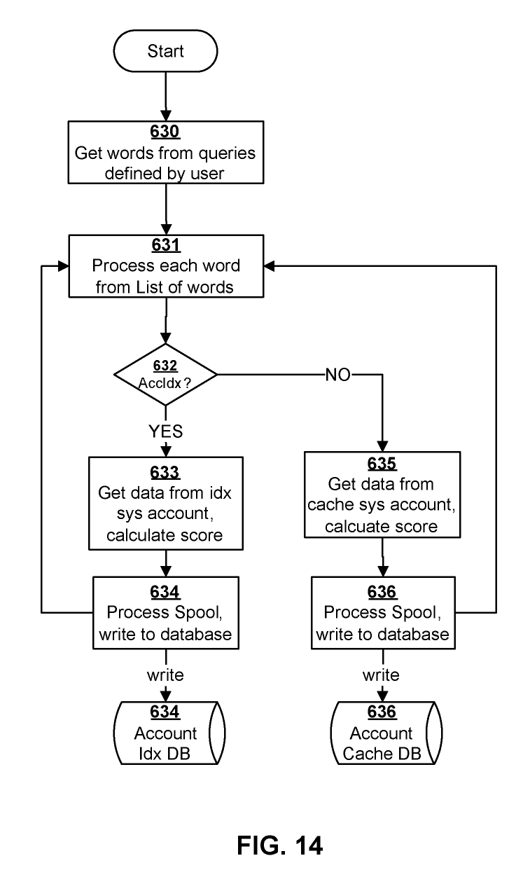

FIG. 14 is a flow diagram of an exemplary process for index creation when a list of queries or words is provided by designers, in accordance with an embodiment of the present invention. Search account designers can create an index that, instead of searching the whole network of sites for all possible words, searches the whole network for only a list of words or a list of queries. In either case, the result is a list of words. If a list of queries is supplied, words are obtained from the queries in step 630. Then each word is processed in step 631. In step 632 it is determined weather the word is from the AccIdx data structure. If so, data is retrieved from the Idx system account and a score is calculated in step 633. Then, a spool is processed and the data is written to an Account Idx database 634 in step 634. The process then returns to step 631 to process the remaining words. If it is determined in step 632 that the word is not contained in the AccIdx data structure, data is retrieved from the Cache system account and the score is calculated in step 635. Then, a spool is processed, and the data is written to an Account Cache database 636 in step 636. The process then returns to step 631 to process the remaining words. The size of index files is smaller than for a normal index and index creation time is much higher.

Community and Social Activities

The preferred embodiment of the present invention provides a community of search designers that creates search accounts and users that use these search accounts. A set of tools is deployed that enable designers and users to share configurations, links and searches. Those skilled in the art, in light of the present teachings, will readily recognize that the number of search designers and users may be configured differently in alternate embodiments of the present invention. For example, without limitation, one alternate embodiment may incorporate only one search designer rather than a community of search designers. Another embodiment, without limitation, may incorporate a search designer and a group of users giving feedback for improving search queries, improving search account configuration.

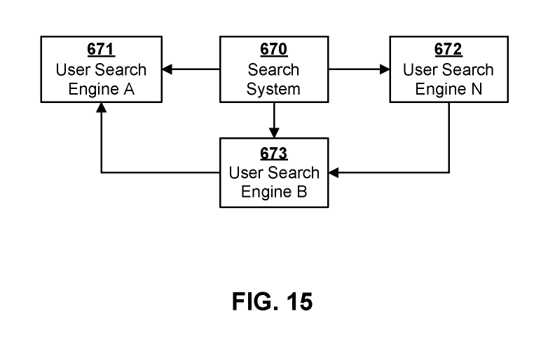

FIG. 15 is a block diagram of exemplary interaction among search accounts, in accordance with an embodiment of the present invention. In the present embodiment, each search designer has an associated number of search accounts that are similar to his search account within a search system 670. User search engines 671, 672 and 673 are able to click from one search account to another within search system 670. Search results are retrieved from the search account being used and from the first X number of results from related search accounts within search system 670. Search designers may define a set of other search accounts related to theirs, and when an user places a search, the results from those accounts will be displayed in a certain region of the browser screen. Users may also define a group of search accounts, selecting the search accounts that they like from a list, and placing a search in all the search accounts.

The community also allows internet users to upload their preferred presentation logic in themes. These themes change the default presentation and also add new presentation functionality that can increase the value of the search services for the community. In the present embodiment, users are also able to place queries in multiple search accounts at the same time, and each result gives credit to the search account used to find the particular result. However, alternate embodiments may be implemented where users may only query one search account at a time. In an alternate embodiment, a group of users can share a search account. In this embodiment, a group leader manages the search account and the other members may participate in setting social links to other search accounts, setting relevance or URLs and domains that link, thus setting relevance of relevance system properties.

Although the preferred embodiment of the present invention comprises all of the parts described in the foregoing, a simplified embodiment comprises the common parts of the system as illustrated by way of example in FIG. 1 and FIG. 2 and the ability to build customized index archives for search accounts as illustrated by way of example in FIG. 3, FIG. 7A, FIG. 7B, FIG. 8, FIG. 10, and FIG. 12. This simplified embodiment does not incorporate the relevance system, the vertical search embodiments (i.e., site list and query list) or the community aspects. In some embodiments, the relevance system may be replaced by another relevance system with search accounts fully operative. If the relevance system is replaced by an alternate relevance system, this relevance system preferably incorporates most of the features of the relevance system described in the foregoing description, although the method by which the relevance is achieved may be modified. However, embodiments of the personalized search system may operate with any other method for determining relevance of resources in any network. Moreover, additional relevance methods can be added to the personalized system in alternate embodiments, not altering the basic nature of the customized system. Additional properties may also be added to the relevance system, such as, but not limited to, knowledge categories, utility categories, new levels for the properties described, and new subject categories. In other alternate embodiments, the relevance procedures described in the foregoing may be used for other search systems, being those systems personalized, customized or not customized at all. Furthermore, the community and marketplace feature may be available as an add-on to the preferred embodiment.

In alternate embodiments of the present invention, users may define the order of search queries rather than search account designers. Some alternate embodiments may also enable users to participate in the configuration of a search account and to provide additional configuration or to vote on the current configuration.

In yet other alternate embodiments, the search results may be embedded in any kind of distributed data structure such as, but not limited to, XML files, JSON objects and any other serialized objects. The XML format can be any format defined by the search account designers, the provider of the services, rich site summary (RSS), or any format defined by publishers. The JSON format can be encoded and decoded under all mayor software platforms like J2EE, PHP, .NET, etc. . . .

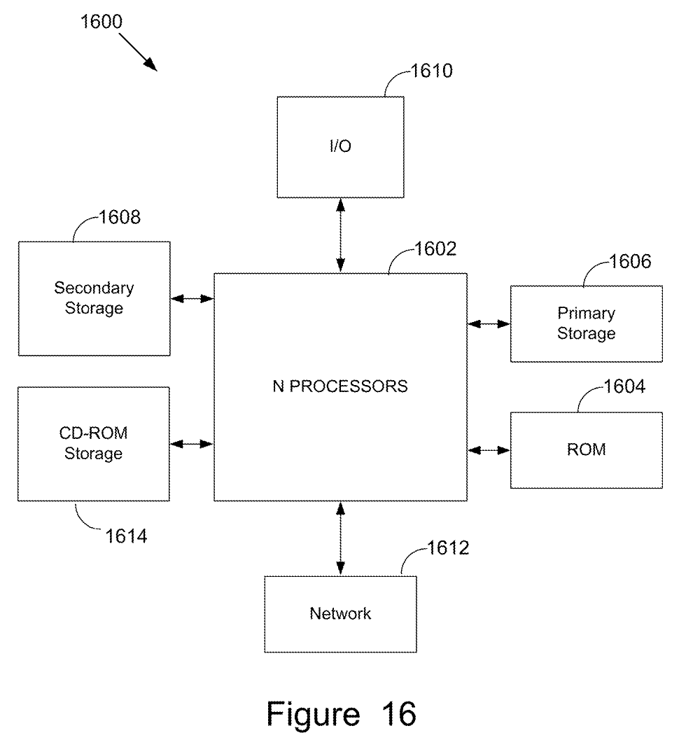

In yet other alternate embodiments, the vertical building of index structures (i.e., search within web pages and sites) may be implemented. In these embodiments, index structures are built with testing and production environments only for a certain number of sites and web pages. Designers have full configuration and personalization as horizontal search accounts FIG. 16 illustrates a typical computer system that, when appropriately configured or designed, can serve as a computer system in which the invention may be embodied. The computer system 1600 includes any number of processors 1602 (also referred to as central processing units, or CPUs) that are coupled to storage devices including primary storage 1606 (typically a random access memory, or RAM), primary storage 1604 (typically a read only memory, or ROM). CPU 1602 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 1604 acts to transfer data and instructions uni-directionally to the CPU and primary storage 1606 is used typically to transfer data and instructions in a bi-directional manner. Both of these primary storage devices may include any suitable computer-readable media such as those described above. A mass storage device 1608 may also be coupled bi-directionally to CPU 1602 and provides additional data storage capacity and may include any of the computer-readable media described above. Mass storage device 1608 may be used to store programs, data and the like and is typically a secondary storage medium such as a hard disk. It will be appreciated that the information retained within the mass storage device 1608, may, in appropriate cases, be incorporated in standard fashion as part of primary storage 1606 as virtual memory. A specific mass storage device such as a CD-ROM 1614 may also pass data uni-directionally to the CPU.

CPU 1602 may also be coupled to an interface 1610 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1602 optionally may be coupled to an external device such as a database or a computer or telecommunications or internet network using an external connection as shown generally at 1612, which may be implemented as a hardwired or wireless communications link using suitable conventional technologies. With such a connection, it is contemplated that the CPU might receive information from the network, or might output information to the network in the course of performing the method steps described in the teachings of the present invention.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing novel means for and/or steps described that the applications designer will selectively decide, depending upon the practical considerations of the particular implementation, to carry out and/or locate within the jurisdiction of the USA. For any claims construction of the following claims that are construed under 35 USC §112 (6) it is intended that the corresponding means for and/or steps for carrying out the claimed function also include those embodiments, and equivalents, as contemplated above that implement at least some novel aspects and objects of the present invention in the jurisdiction of the USA. For example, frontend servers which contain copies of query search data (cache servers) as well as replicated backend servers which contain copies of backend data may be performed and/or located outside of the jurisdiction of the USA while the remaining method steps and/or system components of the forgoing embodiments are typically required to be located/performed in the US for practical considerations. Replicated backend servers would copy information from USA servers into other geographically located servers for the reason of a faster access to data. The functionality and technology related to the present invention would be hosted in the USA servers, while the servers located outside the USA would simply replicate data for easier and faster access. Frontend servers would connect to either the main backend servers in the USA or any replicated backend server geographically distributed to get search data like query results. Updates and new data would be sent to the main backend servers in the USA. Frontend servers would host the web servers that deliver the search account management application that captures the search account configuration (create search accounts, indexes, etc. . . . ) and packages that information in a serialized format either in XML, JSON or any other serialization format. The serialized object is then sent to the backend services located in the USA to create the search account data. In an alternate embodiment, the frontend can hold any data that is needed to be preprocessed before sending it to the backend, as well as any frontend application needed for the system to work (web, presentation, etc. . . . ). The cache services (query copies) would work in this manner: the search procedures would first query the cache services located outside the USA to verify if a search result copy is found. In case found, it would deliver that copy to the user without connecting to the backend services. In case it does not exist, then the frontend would connect to the closest backend service (either the main servers in the USA or the closest server) to get the search result data.

The search account creation procedures can be used in any other system having its own relevancy methods, referencing index data instead of the entities defined in the present innovation to other entities having same functionality or additional functionality but keeping the core principles of the innovation about physical index creation for a set of search accounts inside a common search index.

The relevancy method described here can be used in any other information retrieval system, having personalized index data or just an unique index.

The common index procedures explained in the present innovation could be used in any other information retrieval system.

Other implementations and physical data designs of the search account creation procedures could be implemented sharing the basic principles defined here about having an information retrieval system with a common part and a personalized part with a set of search accounts.

The procedures explained about search accounts for a list of web sites and a list of topics or queries could also be used in any other information retrieval system without the relevance methods here explained or the full search account creation explained.

Having fully described at least one embodiment of the present invention, other equivalent or alternative methods of providing a customizable search system according to the present invention will be apparent to those skilled in the art. The invention has been described above by way of illustration, and the specific embodiments disclosed are not intended to limit the invention to the particular forms disclosed. For example, the particular implementation of the number of data structures in the search system may vary depending upon the size of the particular network being searched. The systems described in the foregoing were directed to implementations with three common data structures, the Idx, IdxAcc and Cache; however, similar techniques are to provide systems with fewer or more data structures. Implementations of the present invention comprising various numbers of data structures are contemplated as within the scope of the present invention. The invention is thus to cover all modifications, equivalents, and alternatives falling within the spirit and scope of the following claims.

What is claimed is:

1. A system for personalization of a search engine for a network, the system comprising:
a least one search account;
a first data structure stored on a computer readable medium for at least storing index data for words each having a number of matching resources less than a first number, said first data structure being common for all search accounts;
a second data structure stored on a computer readable medium for at least storing index data for words each having a number of matching resources greater than or equal to said first number and less than a second number, wherein said second data structure can be personalized for said at least one search account to create a private second data structure for said at least one search account;
a third data structure stored on a computer readable medium for at least storing index data for words each having a number of matching resources greater than or equal to said second number, wherein said third data structure can be personalized for said at least one search account to create a private third data structure for said at least one search account; and
at least one index comprising said first data structure, said private second data structure and said private third data structure where when the search engine responds to a query from a user of a search account, the search engine uses an index corresponding to said search account.

2. The system as recited in claim 1, further comprising a plurality of search accounts, a plurality of private second data structures, a plurality of private third data structures and a plurality of indexes.

3. The system as recited in claim 2, wherein each of said plurality of search accounts further comprises a configuration for personalizing data structures.

4. The system as recited in claim 3, wherein a weight of word location in a resource, a weight of resource properties and weights for linked content based on said configuration.

5. The system as recited in claim 3, wherein said configuration can define relevance of properties of websites.

6. The system as recited in claim 3, wherein at least part of said configuration can be replaced by a website configuration contained in a website to be searched.

7. The system as recited in claim 1, wherein at least index data for a word can be moved between said first, second and third data structures when said number of matching resources increases.

8. The system as recited in claim 3, wherein index data can be organized in word location preferences, resource preferences and link preferences based on said configuration.

9. The system as recited in claim 3, wherein a group of resources can be categorized based on said configuration.

10. The system as recited in claim 2, wherein said indexes contain index data from indexing only a portion of content on the network.

11. A system for personalization of a search engine for a network, the system comprising:
a least one search account;
first means for storing index data for all search accounts;
second means for storing index data that can be personalized for said at least one search account;
third means for storing index data that can be personalized for said at least one search account; and
means for creating at least one index corresponding to said at least one search account where when the search engine responds to a query from a user of a search account, the search engine uses an index corresponding to said search account.

12. The system as recited in claim 11, further comprising a plurality of search accounts where said second and third means store index data for each of said plurality of search accounts and said creating means creates a plurality of indexes corresponding to said plurality of search accounts.

13. The system as recited in claim 12, further comprising means for configuring said plurality of search accounts.

14. The system as recited in claim 11, further comprising means for moving index data between said first, second and third means.

15. The system as recited in claim 12, further comprising means for indexing only a portion of content on the network.

16. A method for personalization of a search engine for a network, the method comprising steps of:
at least storing index data for words in a first data structure where each word has a number of matching resources less than a first number, said first data structure being common for all search accounts;
at least storing index data for words in a second data structure where each word has a number of matching resources greater than or equal to said first number and less than a second number, wherein said second data structure can be personalized for at least one search account to create a private second data structure for said at least one search account;
at least storing index data for words in a third data structure where each word has a number of matching resources greater than or equal to said second number, wherein said third data structure can be personalized for said at least one search account to create a private third data structure for said at least one search account; and
creating at least one index comprising said first data structure, said private second data structure and said private third data structure where when the search engine responds to a query from a user of a search account, the search engine uses an index corresponding to said search account.

17. The method as recited in claim 16, wherein said second data structure can be personalized for a plurality of search accounts to create a plurality of private second data structures, said third data structure can be personalized for a plurality of search accounts to create a plurality of private third data structures and said creating creates a plurality of indexes.

18. The method as recited in claim 17, further comprising a step of receiving configuration information for search accounts for personalization of data structures.

19. The method as recited in claim 18, further comprising a step of determining a weight of word location in a resource, a weight of resource properties and weights for linked content based on said configuration information.

20. The method as recited in claim 18, further comprising a step of defining relevance of properties of websites based on said configuration information.

21. The method as recited in claim 18, further comprising a step of replacing at least part of said configuration information with a website configuration when a website to be searched contains said website configuration.

22. The method as recited in claim 16, further comprising a step of moving at least index data for a word between said first, second and third data structures when said number of matching resources increases.

23. The method as recited in claim 18, further comprising a step of organizing index data in word location preferences, resource preferences and link preferences based on said configuration information.

24. The method as recited in claim 18, further comprising a step of categorizing a group of resources based on said configuration information.

25. The method as recited in claim 17, further comprising a step of indexing only a portion of content on the network based on said configuration information.

26. A method for personalization of a search engine for a network, the method comprising:
steps for at least storing index data for words in a first data structure being common for all search accounts;
steps for storing index data for words in a second data structure that can be personalized for at least one search account;
steps for storing index data for words in a third data structure that can be personalized for said at least one search account; and
steps for creating at least one index corresponding to said at least one search account where when the search engine responds to a query from a user of a search account, the search engine uses an index corresponding to said search account.

27. The method as recited in claim 26, wherein said second data structure can be personalized for a plurality of search accounts to create a plurality of private second data structures, said third data structure can be personalized for a plurality of search accounts to create a plurality of private third data structures and said creating creates a plurality of indexes.

28. The method as recited in claim 27, further comprising steps for receiving configuration information for search accounts for personalization of data structures.

29. The method as recited in claim 28, further comprising steps for replacing at least part of said configuration information with a website configuration.

30. The method as recited in claim 26, further comprising steps for moving index data for a word between said first, second and third data structures.

31. A computer program product for personalization of a search engine for a network, the computer program product comprising:
computer code for at least storing index data for words in a first data structure where each word has a number of matching resources less than a first number, said first data structure being common for all search accounts;
computer code for at least storing index data for words in a second data structure where each word has a number of matching resources greater than or equal to said first number and less than a second number, wherein said second data structure can be personalized for at least one search account to create a private second data structure for said at least one search account;
computer code for at least storing index data for words in a third data structure where each word has a number of matching resources greater than or equal to said second number, wherein said third data structure can be personalized for said at least one search account to create a private third data structure for said at least one search account;
computer code for creating at least one index comprising said first data structure, said private second data structure and said private third data structure where when the search engine responds to a query from a user of a search account, the search engine uses an index corresponding to said search account; and
a computer-readable media for storing the computer code.

32. The computer program product as recited in claim 31, wherein said second data structure can be personalized for a plurality of search accounts to create a plurality of private second data structures, said third data structure can be personalized for a plurality of search accounts to create a plurality of private third data structures and said creating creates a plurality of indexes.

33. The computer program product as recited in claim 32, further comprising computer code for receiving configuration information for search accounts for personalization of data structures.

34. The computer program product as recited in claim 33, further comprising computer code for determining a weight of word location in a resource, a weight of resource properties and weights for linked content based on said configuration information.

35. The computer program product as recited in claim 33, further comprising computer code for defining relevance of properties of websites based on said configuration information.

36. The computer program product as recited in claim 33, further comprising computer code for replacing at least part of said configuration information with a website configuration when a website to be searched contains said website configuration.

37. The computer program product as recited in claim 31, further comprising computer code for moving at least index data for a word between said first, second and third data structures when said number of matching resources increases.

38. The computer program product as recited in claim 33, further comprising computer code for organizing index data in word location preferences, resource preferences and link preferences based on said configuration information.

39. The computer program product as recited in claim 33, further comprising computer code for categorizing a group of resources based on said configuration information.

40. The computer program product as recited in claim 32, further comprising computer code for indexing only a portion of content on the network based on said configuration information.
